(19) United States
(12) Patent Application Publication
(10) Pub. No.: US 2008/0266237 A1
(43) Pub. Date: Oct. 30, 2008

(54) Method for driving a circuit of a field emission backlight panel

(75) Inventors: Li-Yung Lu, Taipei (TW); Zhi-Ming Hong, Taipei (TW)

Correspondence Address: BACON & THOMAS, PLLC, 625 SLATERS LANE, FOURTH FLOOR, ALEXANDRIA, VA, 22314-1176, US

(73) Assignee: Tatung Company, Taipei (TW)

(21) Appl. No.: 11/979,320

(22) Filed: Nov. 1, 2007

(30) Foreign Application Priority Data
Apr. 27, 2007 (TW) 096114927

(51) Int. Cl. G09G 3/36

(52) U.S. Cl. 345/102

(57) ABSTRACT

This present invention relates to a method for driving a circuit of a field emission backlight panel. A group of driving signals with phase shift is sent to a plurality of emitters of a field emission display panel to control the emitters to emit electrons alternately. Therefore, the lighting area of the field emission display panel is increased, and so are the brightness and the uniformity thereof.

### BACKGROUND OF THE INVENTION

1. Field of the Invention

This present invention relates to a driving method, and more particularly, to a method for driving a circuit of a field emission backlight panel.

2. Description of Related Art

Generally, the conventional display device uses a lamp to be a backlight source such as a cold cathode fluorescent lamp, a cathode hot fluorescent lamp, and a light emitting diode. Therefore, the large size display device has been developed due to the growth of manufacturing technique and lighting area of panel. However, if the large size display device uses a wrong backlight source, the large size display device will have some defects such as weak structure or mercury pollution. If the light emitting diode is applied to a backlight source, the light emitted by the light emitting diode can not spread uniformly on the surface of the backlight source, and therefore some optics diaphragms are applied to spread the light on the surface of the backlight source uniformly. Consequently, the field emission panel has been developed for solving the aforementioned problems.

The field emission panel applies high voltage to the gate of triode for controlling emission of electrons on the cathode plate. The electron outputted from the cathode plate is attracted by the anode plate capable of impacting the fluorescent material disposed on the anode plate so as to absorb some energy of the electron for stimulating the fluorescent material to emit light.

However, the conventional driving method is too complex for applying the voltage to the gate of the field emission panel and the emitter as it increases manufacturing difficulty and reduces lighting area thereof.

### SUMMARY OF THE INVENTION

The object of the present invention is to provide a method for driving a circuit of field emission backlight panel to increase the lighting area of the field emission backlight panel.

Another object of the present invention is to provide a method for driving a circuit of field emission backlight panel to increase brightness and uniformity of the field emission backlight panel.

A further object of the present invention is to provide a method for driving a circuit of field emission backlight panel to reduce manufacturing cost.

The present invention provides a method for driving a circuit of field emission backlight panel, applied to a field emission backlight panel having a plurality of emitters separated into different groups, the method comprising: generating a clock signal; generating a plurality of driving signals according to the clock signal; transforming voltage of the plurality of driving signals; and inputting the plurality of transformed driving signals to the groups of emission backlight panel respectively.

The field emission backlight panel can consist any kind of field emission backlight panel comprising a anode plate, a cathode plate, and a spacer, and furthermore the cathode plate comprises a plurality of emitters. The structure of the anode plate or the cathode plate is preferably a flat plate. The anode plate is preferably composed of fluorescent materials. The spacer can be composed of any kind of material, preferably, but not limited to the materials such as glass, polyimide, or other vacuum or high-pressure-sustainable materials.

Each of the aforementioned emitters is preferably composed of an admixture comprising an electronic source material and a conductive material. Each of the plurality of emitters is preferably construed of a bar structure. Each of the emitters is composed of any kind of materials with low work function such as silicon, metal, or carbon base material, and preferably composed of silicon, molybdenum, niobium, diamond membrane, or nano-tubes.

Each of the plurality of driving signals is inputted to the field emission backlight panel through a scan driving unit for controlling the voltage of the emitter, and the voltage of the plurality driving signals respectively is transformed by a transformer electrically connected to the field emission backlight panel and the scan driving unit, and therefore the transformer is preferably used to increase the voltage of the driving signal. Therefore, while the driving signal controls the voltage of one emitter to maintain at a high voltage, the other emitters adjacent to the emitter maintained at low voltage will output at least one electron corresponding to the emitter maintained at the high voltage. The driving signal preferably controls the emitter to output electrons alternately while the adjacent emitters transform voltage between high voltage and low voltage at different time intervals.

Further, the number of the driving signal is preferably, but not limited to two such as a pair of driving signals respectively corresponding to the odd number row and the even number row of the emitters. Each cycle of the driving signals is preferably an integral times of the cycle of the clock signal respectively such as two times. In addition, each of the plurality of driving signals has different phase with each other, and each of the plurality of driving signals has the same frequency or cycle with the others. The waveform of the driving signal is preferably, but not limited to a square wave between a high reference voltage and a low reference voltage.

Therefore, this present invention transmits a group of driving signals having different phases to the emitter disposed on the field emission plate for controlling to emit electrons alternately so as to increase the brightness and the uniformity thereof.

Other objects, advantages, and novel features of the invention will become more apparent from the following detailed description when taken in conjunction with the accompanying drawings.

### BRIEF DESCRIPTION OF THE DRAWINGS

FIG. 1 shows a schematic view of the field emission backlight panel of the first preferred embodiment according to the present invention.

FIG. 2 is a cross-sectional view of the field emission panel of the FIG. 1.

FIG. 3 shows a flow chart of the method for driving a circuit of field emission backlight panel of the first preferred embodiment according to the present invention.

FIG. 4 shows a schematic view of electronic signal of the first preferred embodiment according to the present invention.

FIG. 5 shows a cross-sectional view of the field emission panel of the second preferred embodiment according to the present invention.

### DETAILED DESCRIPTION OF THE PREFERRED EMBODIMENT

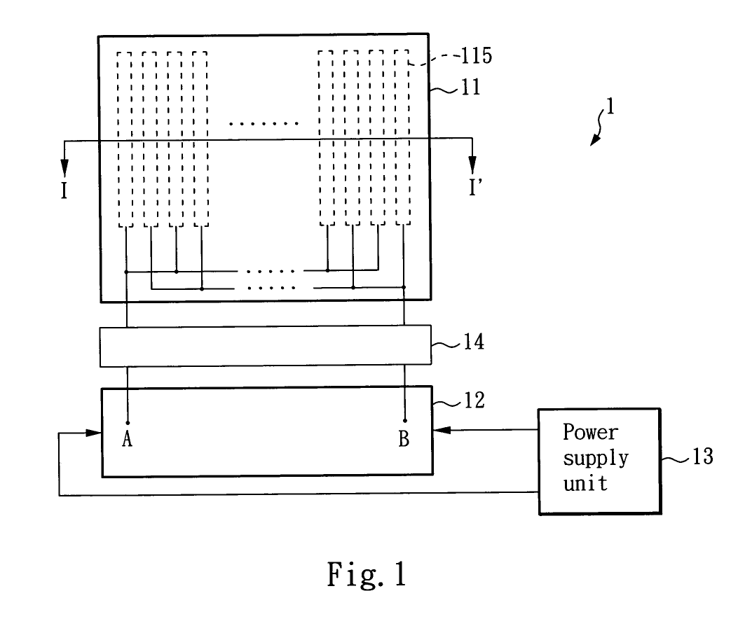

Referring to FIG. 1, the field emission backlight panel 1 comprises a field emission panel 1, a scan driving unit 12, a power supply unit 13, and a transformer unit 14. The power supply 13 electrically connects to the scan driving unit 12, and the transformer 14 electrically connects to the field emission panel 11 and the scan driving unit 12.

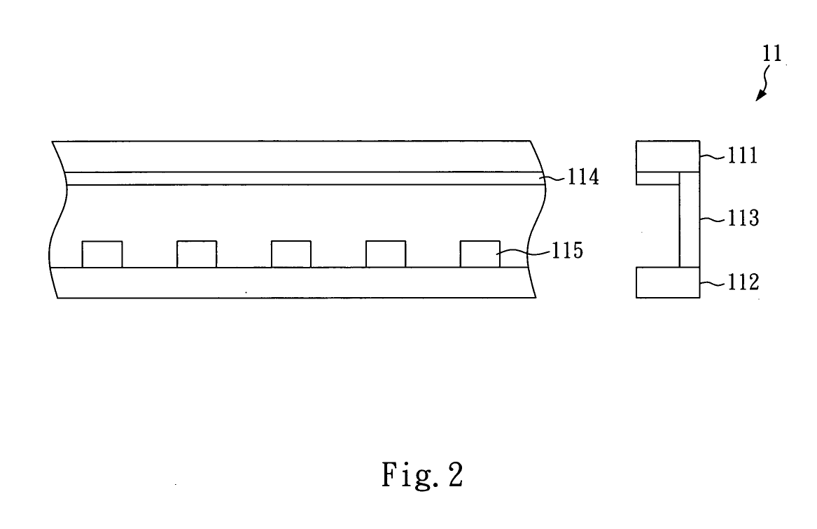

FIG. 2 is a cross-sectional view of the arrangement according to the field emission panel 11 of the FIG. 1 in the direction II′. Referring to FIG. 2, the field emission panel 11 comprises a anode plate 111, a cathode plate 112, and a spacer 113, and therefore the space is maintained in a low pressure status close to the vacuum status for preventing molecule pollution or damage to both anode plate 111 and cathode plate 112. In this embodiment, the pressure is maintained below 10-7 torr.

In this embodiment, the anode plate 111 is a transparent electric conductive plate such as Indium Tin Oxide film facing cathode side and a layer of fluorescent material 114 disposed on the anode plate 111 is on top of this conductive film. The fluorescent material 114 is composed of high voltage fluorescent material or low voltage fluorescent material, and the difference between the two fluorescent materials is about operation voltage. Therefore, when an electron with a voltage exceeding the operation voltage impacts on the fluorescent material 114, the fluorescent material 114 is stimulated to emit light.

In this embodiment, the cathode plate 112 is a silicon-base plate, and a plurality of emitters is disposed on the cathode plate 112. Each emitter is composed of electronic source materials such as nano-tube, conductive material, or metal mixture. In addition, each emitter 115 is construed as a bar structure. In this embodiment, the plurality of emitters is divided into two groups of emitters so that one group of the emitters is arranged on the odd number row, and the other group of emitters is arranged on the even number row.

The spacer 113 is preferably composed of the polyamide having some advantageous features such as mechanical structure strengthening, located between the anode plate 111 and the cathode plate 112 for maintaining a space and low pressure thereof.

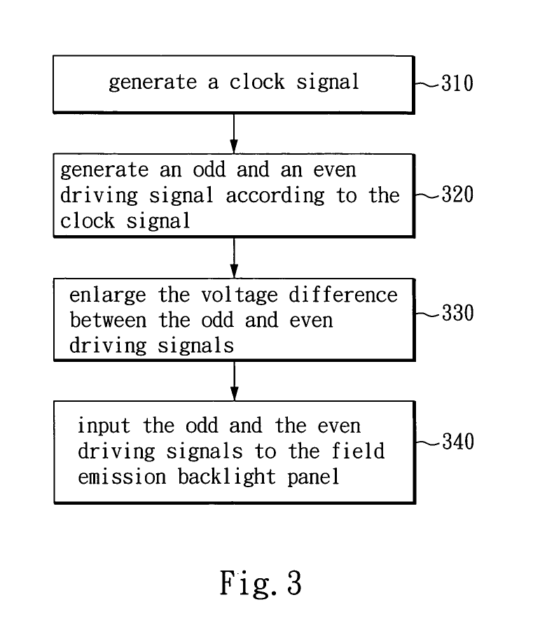

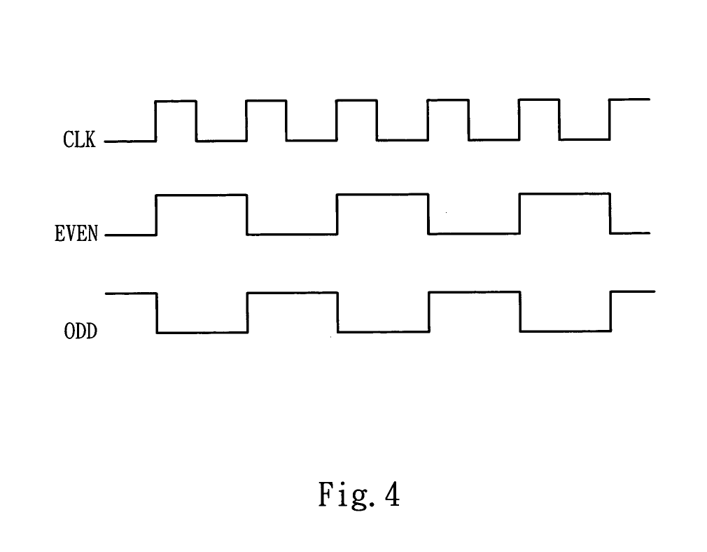

FIG. 3 shows a flow chart of the method for driving a circuit of field emission backlight panel of the preferred embodiment according to this present invention. FIG. 4 shows a schematic view of an electronic signal of the preferred embodiment according to this present invention.

In this embodiment, the scan driving unit 12 uses an oscillator (not shown in figure) to generate a clock signal (CLK), and the clock signal is a cyclic square wave alternately circulated between a high reference voltage and a low reference voltage (STEP 310), and then the scan driving unit 12 will generate a pair of driving signals such as the odd driving signal and the even driving signal according to the clock signal (STEP 320). The odd driving signal and the even driving signal respectively are also a cyclic square wave alternately circulated between a high reference voltage and a low reference voltage, and the odd driving signal has the same frequency with the even driving signal. In addition, the phase difference between the odd driving signal and the even driving signal is about 180 degrees, and the voltage difference between the odd driving signal and the even driving signal is five volts. Furthermore, the scan driving unit 12 transmits the odd driving signal and the even driving signal to the transformer 14 through the outputting end A, B respectively so as to enlarge the voltage difference between the odd driving signal and the even driving signal to 200 volts (STEP 330). After enlarging the voltage of the odd driving signal and the even driving signal, the transformer 14 inputs the odd and the even driving signals to the emitters located on the field emission panel 11 through two wires respectively (STEP 340).

Two groups of emitters 115 respectively receive the odd driving signal and the even driving signal so that the emitter 115 positioned at the odd number row of the plurality of emitters receives the odd driving signal, and the emitter 115 positioned at the even number row of the plurality of emitters receives the even driving signal. At this time, the voltage difference between the emitter 115 positioned at the odd number row of the plurality of emitters and the emitter 115 positioned at the even number row of the plurality emitters is 200 volts. While the odd driving signal is maintained in low reference voltage and the even driving signal is maintained in high reference voltage, the voltage of the emitter 115 positioned at the odd number row of the plurality of emitters 115 is low reference voltage and the voltage of the emitter 115 positioned at the even number row of the plurality emitters 115 is high reference voltage. A huge electronic field is generated between the emitter 115 positioned at the odd number row of the plurality of emitters 115 and the emitter 115 positioned at the even number row of the plurality emitters 115 to output a plurality of electrons, and therefore the emitter 115 positioned at the odd number row of the plurality of emitters 115 is the electronic source, and the emitter 115 positioned at the even number row of the plurality emitters 115 is a gate. The electron transmitted by the emitter 115 positioned at the odd number row of the plurality of emitters 115 is attracted by a positive voltage of the anode plate 111 to impact on the fluorescent material 114 for emitting light. However, while the odd driving signal is maintained in high reference voltage and the even driving signal is maintained in low reference voltage, the voltage of the emitter 115 positioned at the odd number row of the plurality of emitters 115 is high reference voltage and the voltage of the emitter 115 positioned at the even number row of the plurality emitters 115 is low reference voltage. At this time, a huge electronic field is generated between the emitter 115 positioned at the odd number row of the plurality of emitters 115 and the emitter 115 positioned at the even number row of the plurality emitters 115 to output a plurality of electrons for impacting the fluorescent materials 114 to give light.

Therefore, this present invention provides a driving signal with phase difference to the field emission panel for driving the emitter disposed on the field emission panel to output electrons during different time intervals for simplifying the logic process of the driving signal and the structure of the scan driving unit so as to increase brightness and the uniformity of the field emission panel.

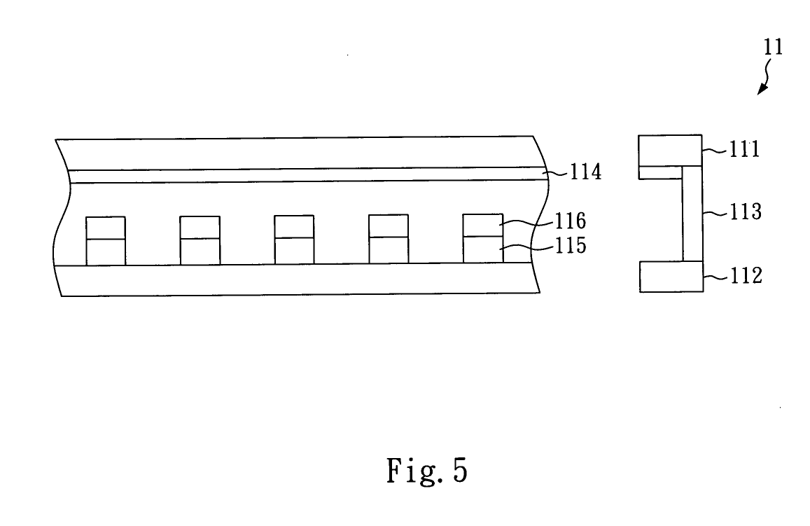

FIG. 5 shows a cross-sectional view of the field emission panel of the second preferred embodiment according to this present invention. The second embodiment only describes the difference from the first embodiment thereinafter. Referring to FIG. 5, a gate layer 116 is formed on the emitter 115 of the cathode plate 112 of the field emission panel 11. Therefore, while the voltage of the gate layer 116 is high reference voltage and the voltage difference between the emitter 115 and gate layer 116 is larger than the operating electric field of the emitter 115, the emitter 115 will output electrons so as to control the lighting status of the fluorescent materials 114. Further, in this embodiment, each of the odd number row of the gate layers 116 and the emitters 115 electrically connects to other odd number row of the gate layers 116 and the emitters 115, and therefore each of the odd number row of the gate layers 116 and the emitters 115 is not connected to the even number row of the gate layers 116 and the emitters 115 respectively. However, each emitter 115 located at the odd number row of the plurality of emitters electrically connects to the gate layer 116 located at the even number row of the plurality of the gate layer 116 for receiving the odd driving signal, the each emitter 115 located at the even number row of the plurality of emitters electrically connects to the gate layer 116 located at the odd number row of the plurality of the gate layer 116 for receiving the even driving signal. While the voltage of the gate layer 116 located at the odd number row of the gate layers 116 is high reference voltage and the voltage of the emitter 115 is the low reference voltage, the emitter 115 located at the odd number row of the plurality of emitters 115 will transmit electrons. At next time interval, while the voltage of the gate layer 116 located at the even number row of the gate layers 116 is high reference voltage and the voltage of the emitter 115 is the low reference voltage, the emitter 115 located at the even number row of the plurality of emitters 115 will transmit electrons.

From the abovementioned, this present invention provides a clock signal to generate a plurality of driving signals. After transforming the voltage of the driving signals, the plurality of driving signals are transmitted to the field emission backlight panel for driving the plurality of emitters to output electrons alternately so as to increase brightness and uniformity of the field emission backlight panel and reduce manufacturing cost.

Although the present invention has been explained in relation to its preferred embodiment, it is to be understood that many other possible modifications and variations can be made without departing from the scope of the invention as hereinafter claimed.

What is claimed is:

1. A method for driving a circuit of field emission backlight panel, applied to a field emission backlight panel having a plurality of emitters separated into different groups, the method comprising:
generating a clock signal;
generating a plurality of driving signals according to the clock signal;
transforming voltage of the plurality of driving signals; and
inputting the plurality of transformed driving signals of the groups to the field emission backlight panel respectively.

2. The method as claimed in claim 1, wherein the voltage of the plurality of driving signals respectively is transformed to a high voltage level.

3. The method as claimed in claim 2, wherein the voltage of the plurality driving signals respectively is transformed by a transformer electrically connected to the field emission backlight panel.

4. The method as claimed in claim 1, wherein the quantity of the driving signal is at least two.

5. The method as claimed in claim 1, wherein each cycle of plurality of the driving signals is an integral times of the cycle of the clock signal respectively.

6. The method as claimed in claim 1, wherein each of the plurality of driving signals has different phase with each other.

7. The method as claimed in claim 1, wherein each of the plurality of driving signals has the same frequency or cycle as the others.

8. The method as claimed in claim 1, wherein the voltage of the plurality of driving signals is between a high reference voltage and a low reference voltage.

9. The method as claimed in claim 1, wherein each of the plurality of driving signals is inputted to the field emission backlight panel through a scan driving unit.

10. The method as claimed in claim 9, wherein the scan driving unit electrically connects to a power supply unit and the field emission backlight panel.

11. The method as claimed in claim 1, wherein the plurality of driving signals control the voltage relative to the plurality of emitters located on the field emission backlight panel.

12. The method as claimed in claim 11, wherein the adjacent emitters respectively have different voltage with each other at the same time interval.

13. The method as claimed in claim 11, wherein each of the emitters is composed of an admixture comprising an electronic source material and a conductive material.

14. The method as claimed in claim 11, wherein each of the plurality of emitters is construed of a bar structure.

15. The method as claimed in claim 11, while the plurality of driving signals control the plurality of emitters to maintain at a low voltage, the plurality of emitters transmit at least one electron.

16. The method as claimed in claim 15, where two adjacent emitters transmit the at least one electron alternatively.
